(19) United States
(12) Patent Application Publication
(10) Pub. No.: US 2019/0216113 A1
(43) Pub. Date: Jul. 18, 2019

(54) REMOVAL OF CONTAMINANT FROM ORGANIC MASS

(71) Applicant: SEACROP LTD., Kfar HaMaccabi (IL)

(72) Inventor: Itai KATZ, Nofit (IL)

(21) Appl. No.: 16/329,473

(22) PCT Filed: Aug. 28, 2017
(86) PCT No.: PCT/IL2017/050960

§ 371 Date: Feb. 28, 2019

(30) Foreign Application Priority Data
Aug. 29, 2016 (IL) 247522

(51) Int. Cl. A23L 5/20; A23K 10/30; A23L 17/00; B01D 61/24; B01D 21/26

(52) U.S. Cl. CPC A23L 5/276; A23K 10/30; A23V 2002/00; B01D 61/243; B01D 21/262; A23L 17/00

(57) ABSTRACT

Disclosed herein is a method for removing heavy metals from biomass, performed by contacting the biomass with an acid, thereby producing an acidic suspension, solution, paste or a mixture thereof, followed by separating the heavy metals from said biomass, thereby removing the heavy metals from the biomass.

### CROSS-REFERENCE TO RELATED APPLICATIONS

This application claims the benefit of priority from IL Application No. 247522 filed on Aug. 28, 2016. The content of the above document is incorporated by reference in its entirety as if fully set forth herein.

### FIELD OF THE INVENTION

The present invention, in some embodiments thereof, relates to a method for removal of contaminants (e.g., heavy metals) from organic mass.

### BACKGROUND OF THE INVENTION

Marine bio-production is carried out mostly by unicellular algae and bacteria, which constitute, together with a variety of non-photosynthetic creatures what is known as Plankton. Plankton is a general term describing the group of organisms that exist suspended in the water and that lack the ability of self-propulsion. Plankton consists the very base of the marine food chain and contains within itself its first few links.

Creatures consisting plankton have particularly high nutritional values. They contain high levels of protein and fat, and are also rich in various rare compounds, such as carotenoids and omega 3 fatty acids, which are renowned for their importance to man and animal health. Plankton concentrations range from dozens of parts per billion (ppb's) in poor waters to several parts per million (ppm's) in rich waters. Their proliferation is rapid, depends mostly on the availability of sunlight and mineral nutrients, and is hardly affected by predation, although the burden imposed by microbial predation (e.g. bacteriophage viruses predation) is significant.

Despite the nutritional benefits and the seemingly unlimited harvestable pool (which is renewable too) the commercial use of planktonic creatures as food material is rather limited, and makes up but only a fraction of a percent of the entire food market.

Wild planktonic material obtained by filtration is contaminated by large amounts of suspended dust and sand, together with pollutants such as bits of plastics of all sorts. These contaminations, which may amount to the bulk of sea water filtration residue, degrade the quality of the obtained plankton material to the point of rendering it worthless. A yet grater problem is that various planktonic creatures tend to accumulate toxic heavy metals, such as lead, mercury and arsenic. Such creatures tend to accumulate these elements to concentrations that may be as high as 10,000 fold the ones found in the water they live in, and beyond. These elements are extremely harmful to terrestrial creatures already at trace amounts.

U.S. Pat. No. 3,758,313 discloses a food concentrate being prepared in a container by dialysis of a liquid food product portion sealed in a film bag or other container having a semi-permeable membrane wall, against a suitable aqueous salt dialyzing solution.

### SUMMARY OF THE INVENTION

The present invention, in some embodiments thereof, relates to a method for removal of contaminant (e.g., heavy metals) from organic mass.

According to an aspect of some embodiments of the present invention, there is provided a method for removing a heavy metal containing marine-originated biomass, the method comprising: (a) contacting said biomass with a non-oxidizing acid, thereby producing an acidic suspension, paste or a mixture thereof, and (b) separating the heavy metal from the biomass, thereby removing the heavy metal from the biomass.

In some embodiments, the marine-originated biomass is a plant. In some embodiments, the biomass is plankton. In some embodiments, the marine-originated biomass is derived from a unicellular organism. In some embodiments, the marine-originated biomass is derived from a prokaryotic organism. In some embodiments, the marine-originated biomass is derived from filter feeder organism.

In some embodiments, the heavy metal is selected from the group consisting of lead, mercury, arsenic, and cadmium.

In some embodiments, the method further comprises a step of: (i) disrupting the membranes present in the biomass prior to step (a), thereby liberating content of enclosed compartments (e.g., cells).

In some embodiments, the method further comprises a step of (ii) raising the specific gravity of the liquid portion of the paste.

In some embodiments, the liquid portion is characterized by a specific gravity value greater than 1, e.g., at least 1.1.

In some embodiments, the method further comprises a step of centrifuging the paste, or the suspension thereby precipitating a mineral content, and separating thereof from the paste or from the suspension.

In some embodiments, the step of centrifuging is performed at 1,000 g to 10,000 g.

In some embodiments, the acid is a material selected from the group consisting of hydrochloric acid (HCl), and a carboxylic acid.

In some embodiments, the carboxylic acid is one or more materials selected from the group consisting of formic acid, acetic acid, citric acid, oxalic acid, butyric acid, lactic acid, malic acid, and pyruvic acid.

In some embodiments, the pH of the suspension is below 6, following the step (a). In some embodiments, step (b) is performed by osmosis. In some embodiments, the osmosis is performed by semipermeable membrane. In some embodiments, the osmosis is performed by dialysis.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-B present bar graphs results for lead (FIG. 1A) and arsenic (FIG. 1B) concentration (ppm) for three different species. In each pair of bar graphs the left (longer) bar left) refers to the native (before treatment) and the right bar refers to the results after the employing the method as described in the Examples section. The upper black horizontal line marks the maximum permissible level for algae additives in feed. The lower horizontal line marks the maximum permissible level for general feed ingredients (e.g., barley, corn, etc.).

### DETAILED DESCRIPTION OF THE INVENTION

The present invention, in some embodiments thereof, relates to a method for removal of heavy metals from an organic mass.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The primitive marine creatures, which are the most abundant, accumulate heavy metals. The present inventors have contemplated a process that on the one hand renders the enormous reservoir of highly nutritious marine biomass, available for beneficial use, and, on the other hand, liberates the heavy metals into a solution with a cheap and nondestructive means.

As further disclosed hereinbelow, the use of an acid treatment in succession to membrane disruption simultaneously may reduce the amount of unwanted minerals (e.g., carbonate based minerals), other unwanted small molecules (e.g. toxic small-sized water soluble molecules, small-sized organic molecules having strong odor), and/or heavy metals content. Exemplary small-sized organic molecules are molecules comprising groups selected from, without being limited thereto, SH2, dimethyl sulfide, and bromophenoles.

Additional non-limiting exemplary small-sized organic molecules are e.g., dictyopterene A, dictyopterene B, dictyopterene C, dictyopterene C′, and dictyopterene D.

The disclosed centrifugation scheme, which, in some embodiments, separates unwanted materials from the organic substance, is used in a non-orthodox fashion, and outside of the common disciplines. Whilst centrifugation is usually used to separate between two phases, e.g. liquids and solids, oil and water or fluids of various densities that do not dissolve one another, the disclosed application presents, in some embodiments thereof, a centrifugation process which is used to separate solids of a fine consistency and similar size distribution, in a nondestructive manner.

The present invention provides, in one embodiment, a method for removing contaminants (also referred to as “pollutants”) from an organic mass containing such contaminants. In some embodiments, the organic mass is a biomass. In some embodiments, the biomass is a marine-originated biomass. In some embodiments, the marine-originated biomass is or derived from a plant.

In some embodiments, the method comprises the step contacting the organic mass with an acid, and separating the heavy metal from the organic mass, thereby removing one or more heavy metals from the organic mass. In some embodiments, the method comprises the step drying the organic mass, prior to the contacting the organic mass with the acid.

In some embodiments, the step of contacting the organic mass with the acid produces an acidic suspension (or solution) comprising the mass.

In some embodiments, the term “suspension” is defined herein as a medium (e.g., aqueous medium) that comprises insoluble particles of the mass.

In some embodiments, by “remove”, or any grammatical derivative thereof, it is meant to refer to reducing the amount of at least e.g., 1%, 5%, 10%, 20%, 30%, 40%, 50%, 60%, 70%, 80%, 80%, or 99%, of the contaminant (e.g., the heavy metal(s)). In some embodiments, by “remove”, or any grammatical derivative thereof, it is further meant to refer to “selective removal”, that is, less than 30%, less than 20%, less than 10%, or less than 5% of the organic mass are removed during the disclosed method.

In some embodiments, the term “organic mass”, as used herein, means a composition having C—H bond. In some embodiments, the term “organic mass”, as used herein, means a composition derived from a living organism. In some embodiments, the phrase “derived from” means “originates from”.

In some embodiments, the (chemical) integrity of the biomass remains substantially the same (i.e. not being decomposed) during the disclosed method. That is, in some embodiments, the method is carried out without breaking bonds in the variety of organic molecules of the biomass. In some embodiments, by “bonds in a variety of organic molecules”, it means that at least 50%, at least 60%, at least 70%, at least 80%, at least 90%, or at least 95% of the C—H bonds in the biomass remain unreacted. In some embodiments, by “bonds in a variety of organic molecules”, it means that at least 50%, at least 60%, at least 70%, at least 80%, at least 90%, or at least 95% of the C—C bonds in the biomass remain unreacted.

Hence, in some embodiments, the disclosed process offers the possibility of removing toxic elements from a biomass in a non-destructive manner.

In some embodiments, by “non-destructive manner” it is further meant that e.g., at least 20%, at least 30%, at least 40%, at least 50%, at least 60%, at least 70%, at least 80%, or at least 90% of the total mass of the proteins, the carbohydrates, the lipids, the and the nucleotides, remain unreacted. In some embodiments, by “non-destructive manner” it is further meant that e.g., at least 20%, at least 30%, at least 40%, at least 50%, at least 60%, at least 70%, at least 80%, or at least 90% of the total mass of the proteins, the carbohydrates, the lipids, and the nucleotides, remain physiologically acceptably edible.

As exemplified in the Examples section that follows, the disclosed process allows to drastically remove the toxic elements so that the concentrations of these toxic elements in the biomass may be reduced by up to around 3 fold, which, in some embodiments, is sufficient to render an inedible product edible anew.

As used herein, the term “contaminant” may refer to any toxic ingredient or pollutant.

In some embodiments, the contaminant is a polymer.

In some embodiments, the contaminant is a metal. In some embodiments, the metal is a heavy metal. In some embodiments, by the term “heavy metal” it is meant a metal in accordance with the definition of the European Environment Agency, namely a metal or metalloid which is stable and which has a density greater that 4.5 gram/cm³.

In some embodiments, the heavy metal is lead. In some embodiments, the heavy metal is copper. In some embodiments, the heavy metal is nickel. In some embodiments, the heavy metal is cadmium. In some embodiments, the heavy metal is platinum. In some embodiments, the heavy metal is zinc. In some embodiments, the heavy metal is mercury. In some embodiments, the heavy metal is arsenic.

In some embodiments, the term “heavy metal” also refers to a combination of two or more from: lead, copper, nickel, cadmium, platinum, zinc, mercury, and arsenic.

In some embodiments, the term “heavy metal” refers to an organic heavy metal compound. In some embodiments, the organic heavy metal compound is a heavy metal alkyl. In some embodiments, the alkyl is a C1-C10 alkyl.

In some embodiments, the phrase “marine-originated biomass” refers herein to an organism which is defined by its innate habitat, i.e. an open sea grown organism, or any other water source, where a heavy metal uptake is feasible.

In some embodiments, by “marine-originated biomass” it is meant to refer to organisms at the bottom of the food chain. In some embodiments, by “marine-originated biomass” it is to refer to biomass that originates from unicellular organism. In some embodiments, by “marine-originated biomass” it is meant to refer to biomass originates and/or prokaryotic organism. Non-limiting examples include zooplankton, prokaryotes (e.g., cyanobacteria), and filter feeders e.g., barnacles, bryozoa, hydrozoa, ascidians.

As used herein, the term “plant” may refer to whole plants, plant organ (e.g., leaves, stems, roots), plant tissue, seeds, and plant cells and progeny thereof. Plant cells, as used herein may be derived from, without limitation, seeds, e.g., seed suspension cultures, embryos, meristematic regions, callus tissue, leaves, roots, shoots, gametophytes, sporophytes, pollen, and microspores.

In some embodiments, the term “plant” refers to algae. It is to be understood that the terms “plant” and “algae,” and even “bacteria”, as used herein, do not have a strict taxonomical distinction and may include overlapping members due to the lack of a consensus uniform taxonomy system and varied colloquial use of these terms. For example, cyanobacteria (commonly referred to as blue-green algae) were historically considered to be “algae” but modernly are considered to be bacteria. As such, in some embodiments, the terms “plant”, “algae”, and “bacteria” as used herein are meant to encompass overlapping members.

In some embodiments, the term “plant” refers to marine plant. In some embodiments, the term “marine plants” refers to plankton.

In some embodiments, the term “plankton” refers to any marine organisms that inhabit bodies of water, including, but not limited to, marine source (e.g., oceans, seas), lakes, rivers, and streams. Typically, but not exclusively, plankton are drifting organisms that flow with water current. Accordingly, plankton are conveniently referred to by their ecological niche rather than taxonomic classification. In some embodiments, the term “plankton” as used herein can refer to organisms classifiable as animals, plants, algae, and/or bacteria without mutual exclusion.

In some embodiments, the term “plankton” refers to debris of plankton, fragments or spilled content thereof.

In some embodiments, the term “plankton” refers to phytoplankton. In some embodiments, the term “plankton” refers to zooplankton.

In some embodiments, the term “phytoplankton” is meant to include the photosynthetic species, such as, without being limited thereto, the groups of cyanobacteria, diatoms, and dinoflagellates, as well as their cyst and spore stages.

In some embodiments, the term “zooplankton” is meant to include drifting animal species that include everything from copepods, jellyfish, and shrimp to a broad range of macrovertebrate and macroinvertebrate egg and larval stages.

In some embodiments, the disclosed method is applied to other materials of marine origin such as, without being limited to, sessile marine invertebrates, tunicates, ascidians, seaweeds, sea anemones, filter feeders, fouling material and marine biofilms.

In some embodiments, the acid is non-oxidizing acid. In some embodiments, the term “non-oxidizing acid” as used herein, generally refers to an acid that cannot act as an oxidizing agent. In some embodiments, suitable non-oxidizing acids include both inorganic and organic acids.

Exemplary non-oxidizing inorganic acids include, without limitation, hydrochloric acid, hydrobromic acid, mixtures thereof and the like.

In exemplary embodiments, the acid is hydrochloric acid.

Exemplary non-oxidizing organic acids include, without limitation, a carboxylic acid or a derivative thereof, selected from, without being limited thereto, citric acid, oxalic acid, lactic acid, malic acid, pyruvic acid, formic acid, acetic acid, butyric acid, propionic acid, mixtures thereof and the like.

In some embodiments, by “contacting with acid” it is meant to refer to adding the acid until a final and stable and predetermined pH level is reached.

In some embodiments, the predetermined pH level is between −2 and 6, e.g., −2, −1, 0, 1, 2, 3, 4, 5, or 6, including any value and range therebetween.

A non-limiting exemplary pH level is 0.3, corresponding to an acid normality of 0.5, or pH 0, corresponding to an acid normality of 1.

In some embodiments, the disclosed method further comprises a step of disrupting the cell membrane of the plant (e.g., plankton) prior to its contacting with the acid, thereby producing a paste, a suspension or a solution having a liquid portion.

In some embodiments, disrupting of the membrane may be conducted by a method known in the art, for example and without limitation, using physical shear force, by heat treatment, extrusion, homogenation, detergent treatment, solvent treatment, or the like. In some embodiments, the method is devoid of using any oxidative agent.

Non-limiting exemplary disrupting methods include, but are not limited to, freezing and thawing, drying, heating, pulverizing, sonication, mechanical homogenization, detergent treatment, and base or acid treatment.

In some embodiments, the term “paste” as used herein, refers to a smooth or semi-smooth thick flowable or malleable material having a large solids content held in suspension in a liquid (e.g., water). The terms “paste” and “mass” may be used hereinthroughout interchangeably.

In some embodiments, the disclosed method further comprises a step of reducing a liquid (e.g., water) portion of the paste (or of the suspension).

In some embodiments, by “reducing a liquid portion” it is meant to refer to drying, or at least partially removing the liquid from the paste, which may be conducted by a method known in the art (e.g., by heating).

In some embodiments, the liquid portion is reduced such that the specific gravity of the liquid portion of the paste exceeds 1.1. In some embodiments, the liquid portion is reduced such that the specific gravity of the liquid portion of the paste exceeds 1.2. In some embodiments, the liquid portion is reduced such that the specific gravity of the liquid portion of the paste exceeds 1.3. In some embodiments, the liquid portion is reduced such that the specific gravity of the liquid portion of the paste exceeds 1.4. In some embodiments, the liquid portion is reduced such that the specific gravity of the liquid portion of the paste exceeds 1.5.

In some embodiments, the term “specific gravity” as used herein refers to the ratio of the density of the liquid to the density of a reference. In some embodiments, the reference is water.

In some embodiments, the specific gravity may be increased by adding a salt (e.g., KCl) or a sugar to the liquid.

In some embodiments, the method further comprises a step of centrifuging the paste, thereby reducing (i.e. at least partially removing) a mineral content from the paste.

Herein, the term “centrifuge” relates to using centrifugal force for separating substances of different densities by a machine. The centrifugation may be performed at e.g., 100 g, 200 g, 300 g, 400 g, 500 g, 600 g, 700 g, 800 g, 900 g, 1000 g, 2000 g, 3000 g, 4000 g, 5000 g, 6000 g, 7000 g, 8000 g, 9000 g, or 10000 g, 11000 g, 12000 g, 13000 g, 14000 g, 15000 g, 16000 g, 17000 g, 18000 g, 19000 g, or 20000 g, including any value and range therebetween.

In exemplary embodiments, the centrifugal force is set to 4000-7000 g.

Herein “g” refers to g-force.

In some embodiments, the term “g-force” refers to a ratio of square of angular velocity times the radius, divided by the gravitational acceleration of the earth at sea level (about 9.8 meters per second square).

In some embodiments, the step of centrifuging the paste is performed for 1 minute, 2 minutes, 3 minutes, 4 minutes, 5 minutes, 6 minutes, 7 minutes, 8 minutes, 9 minutes, or 10 minutes, including any value and range therebetween.

In exemplary embodiments, the step of centrifuging the paste is performed for 2 to 5 minutes.

In some embodiments, the step of centrifuging is performed continuously. In some embodiments, the step of centrifuging is performed repeatedly over a defined period of time.

In some embodiments, the term “mineral” is employed herein in a generic sense to include, without being limited thereto, sand, dust, calcium carbonate fragments, silicates and the like.

In some embodiments, the step of separating the heavy metal from the biomass (e.g., plant) is performed by subjecting the acidic paste to a process of osmosis.

In some embodiments, the term “osmosis” describes a diffusion process, wherein a solvent and dissolved molecules move through a selectively permeable membrane (e.g., permeable to solvent but not to solute or permeable to some of the solutes but not to others), which is separating at least two solutions of different solute concentration. This diffusion process aims for equalization of the solute concentrations. In some embodiments, the selectively permeable membrane used in osmosis is selected from a semi-permeable membrane, an osmosis membrane, and a dialysis membrane.

In some embodiments, the term “selectively permeable membrane” as used herein means that the membrane layer used for selective passage of certain molecules or ions does not allow passaging of other molecules or ions. The rate of passage may depend in part on the pressure and the concentration gradients across the membrane, the temperature of the system, as well as on the permeability of the membrane to each molecule or ion species. In some embodiments, the permeability of the selectively permeable membrane depends, in part, on one or more properties (of the species), being selected from: size, solubility, chemical functionality, electric charge, polarity, mobility, magnetic susceptibility and the like.

In some embodiments, the osmosis process is performed by a membrane technology selected from, without limitation, dialysis, membrane filtration, such as nano-, ultra-, and micro-filtration. In some embodiments, the osmosis refers to reverse osmosis.

Hence, in some embodiments, the acidified paste is subjected to osmosis using a pool of medium of similar composition (e.g., similar solvent, pH or properties of the sort) but with a low concentration of the heavy metals destined for removal. By “low concentration” it is meant to refer to a concentration lower than the target concentration for these metal elements.

Osmosis between material mass (e.g., paste) and clean pool may occur through any kind of semipermeable membrane known in the art.

In some embodiments, the term: “reverse osmosis” refers to pressure driven transport of water and/or solute that permeates the membrane through a semipermeable membrane in opposition to an osmotic potential. In some embodiments, reverse osmosis allows to assist and speed up spontaneous osmosis.

In some embodiments, the semipermeable membrane is an ion exchange membrane. In some embodiments, the semipermeable membrane is a porous membrane. In some embodiments, the semipermeable membrane is an ultra-filtration membrane. In some embodiments, the semipermeable membrane is hydrophilic/hydrophobic selective membrane. In some embodiments, the semipermeable membrane is a charge selective membrane.

In exemplary embodiments, the osmosis is performed by a dialysis process.

That is, in some embodiments, the paste may be dialyzed to a clean pool through a membrane, for example and without limitation, a regenerated cellulose (RG) membrane.

In some embodiments, the RG membrane is chemically resistant to an acidity of up to pH −2. In some embodiments, the dialysis is performed against an acidic solution having normality range of 0.01 to 1.5 N. In some embodiments, the dialysis is performed against an acidic solution having normality range of 0.1 to 1 N.

In some embodiments, the dialysis membrane has a pore size resulting in a cutoff of 1 kD, 2 kD, 3 kD, 4 kD, 5 kD, 6 kD, 7 kD, 8 kD, 9 kD, 10 kD, 11 kD, 12 kD, 13 kD, 14 kD, 15 kD, 16 kD, 17 kD, 18 kD, 19 kD, or 20 kD, including any value and range therebetween.

In some embodiments, the treated mass can be further subjected to osmosis into a pool neutral fresh water to reduce acidity and/or to reduce salt levels.

In some embodiments, the method described hereinabove further comprises the steps of: (i) evaluating heavy metals content in the acid treated organic mass, and (ii) comparing the heavy metal content to the non-acid treated organic mass, thereby determining heavy metals removal.

In some embodiments, the mass is further dried or delivered as is for further use.

General

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

### EXAMPLES

Reference is now made to the following examples which, together with the above descriptions, illustrate the invention in a non-limiting fashion.

At the beginning of this section the experimental procedures and results are presented, demonstrating the feasibility of the disclosed process. Three samples of wild costal marine creatures were tested: the two ascidians phalusia nigra and herdmania mumus, and the shallow water dwelling anemone Anemonia Sulcata. Samples were dried and weighed.

### Example 1

### Ascidians

Two species of ascidians were tested: phalusia nigra and herdmania mumus. Both were collected from various under-water artificial structures 0.5-2 Km off the shore of Cezeria (Israel) along early spring of 2015.

In exemplary procedures, samples were washed one by one and dried in Q-dry. Both specimens were washed as follows: portions weighing about 1.5 grams dry weight each were simply rinsed (each species by itself) in 40 ml of 6 N hydrochloric acid for several minutes. Next, samples were poured onto a filter paper on a funnel. The dripping of the acid through the paper is slow and takes about 2 hours to complete.

Finally, the samples were squeezed against absorbing paper to release excess solution. As a control, a dry portion of both specimens was taken without HCl wash. Washed and control samples were subsequently incubated in 2.6 ml of 70% nitric acid which dissolved them. The digested samples were diluted in 40 ml of water and filtered through a 0.4 μm syringe filter. The filtered solution was measured in a Thermo-Scientific icap6300 Inductively Coupled Plasma (ICP) spectrometer.

The results (Table 1) present the concentration of the examined heavy elements in their weight concentration in the samples. That is, the weight of metals divided by dry weight of sample.

The results for Lead are presented in Table 1 below.

TABLE 1

| | Pb native | Pb treated | As native | As treated |
|---|---|---|---|---|
| | (ppm) | (ppm) | (ppm) | (ppm) |
| phalusia nigra | 2.17 | 0.823 | 6.3 | 2.5 |
| herdmania | 7.565 | 0 | 4.95 | 1.39 |
| mumus | | | | |

As can be seen, the treatment drastically removed the toxic elements so that the concentrations of these toxic elements in the sample were reduced by around 3 fold, which is sufficient to render an inedible product edible anew.

### Example 2

### Anemonia Sulcata

In exemplary procedures, the anemone sample was subjected to dialysis in 1N and 0.5N HCl environments.

The Dialysis Process for the Anemonies:

samples of wild anemonia sulkata were collected from Shikmona site in Haifa (Israel) during the summer of 2015. Samples were cleaned by hand one by one from rocks and sand. Samples were then frozen and subsequently thawed and centrifuged at 5000 RPM in a 50 ml plastic falcon in a swing-out centrifuge. The falcons with the samples were frozen again and the tips of the falcons, containing most of the mineral debris, were sawed off. Samples were then dried in a Q-dry machine and the dried matter was crushed to rough powder.

The obtained sample was then introduced into a dialysis bag by spectra/pore of regenerated cellulose with a 6 KD cutoff. The bag was treated according to vendor instructions which include soaking in distilled water for half an hour followed by thorough rinsing. Whilst in the bag, the sample was wetted by the acid solution of the dialysis, which was either 1N or 0.5N of HCl.

The dialysis bag was tied sealed at both ends by standard pluming Teflon. Samples of roughly 1.5 gram initial dry weight were incubated in about 1 liter and 0.5 liter of acid wash solution, for the 0.5N and 1N acid concentrations, respectively, with constant magnetic stirring. Following incubation of about 21 hours, samples were taken out of wash solution and their excess fluids were drained. Samples were then dried in a kitchen baking oven for 5 hours at 65° C. Samples were then dissolved in nitric acid for ICP analysis as described above for ascidians. The results for the ICP analysis are shown in Table 2:

TABLE 2

| | Pb native | Pb treated | As native | As treated |
|---|---|---|---|---|
| | (ppm) | (ppm) | (ppm) | (ppm) |
| anemonia | 0 | — | 27.16 | 3.1 |
| sulcate 0.5N | | | | |
| anemonia | 0 | | 27.16 | 3.3 |
| sulcate 1N | | | | |

As can be seen, a drastic reduction in heavy metal content, namely arsenic, is observed. It is surprising that the effectiveness of the process is greater at the lower acidity, and this can be attributed, without being bound by any particular theory, to the fact that a larger volume of wash fluid had been employed and was the factor responsible for the more effective dialysis. The results demonstrate the feasibility of the disclosed process in reducing heavy metal content in a manner drastic enough to render the treated material safe for use as a feed ingredient.

The fat and protein content of the treated material was observed and it was found that it was of high nutritional value. For the sake of nutritional assessment, two tests were conducted: one for the native material and one for a dialysis treated material. Indeed, for technical reasons, the two samples did not originate from the same batch: the native material was collected on February 2015 while the treated material was collected on late spring early summer of 2015, both from Shikmona site (Israel). The treated material has undergone a dialysis process identical to the one described above, but with some minor exceptions. In this dialysis process approximately 20 grams of anemonia sulkata dry matter were used from the batch described above, and were dialyzed in 1 litter of 0.5N HCl solution.

The washed solutions were replaced three times and the incubation times were 4.5, 18 and 24 hours, respectively. Sample was then drained and dried (24 hours in kitchen baking oven at 65° C.) and sent to a certified lab (Miluda Migel) for nutritional analysis. The native sample of anemonia sulkata was also sent to that lab for an identical analysis.

The results are shown in Table 3.

TABLE 3

| | Sample state | Fat by hydrolysis | Kjeldahl N content |
|---|---|---|---|
| anemonia | Dry | 10.6% | 8.21% |
| sulcate native | | | |
| anemonia | Dry | 62.8% | 8.82% |
| sulcate 0.5N | | | |

The dialysis process reduced a considerable, relative amount of the protein content of the sample, but nevertheless, it retained a significant portion of it. The fat content was retained to a very large extent, and this can be deduced despite the fact that two different batches were compared here. It has been demonstrated (data not shown) that the ash content has dramatically decreased, practically to zero.

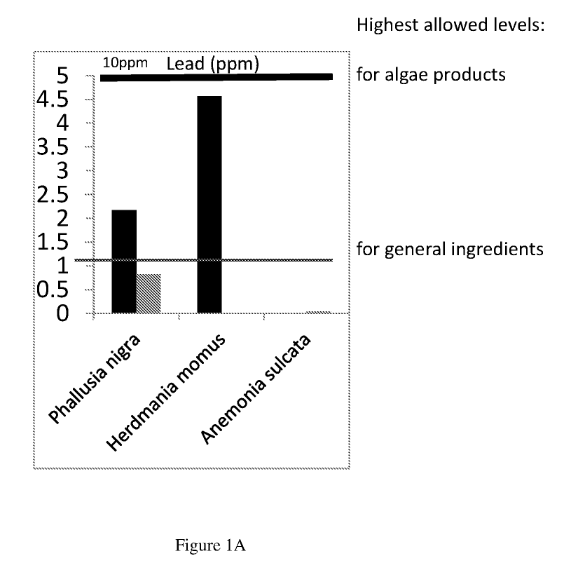

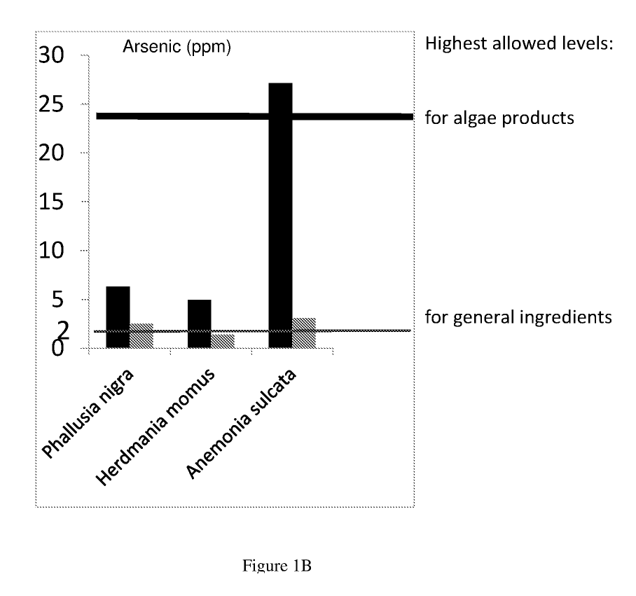

Reference is made to FIGS. 1A-B presenting bar graphs results for lead (FIG. 1A) and arsenic (FIG. 1B) concentration (ppm) for three different species.

As a conclusion, the acid dialysis process improved the quality of the samples used in terms of their commercial value as feed ingredient. It did so particularly by lowering the amount and the concentrations of toxic heavy metals to acceptable levels, but also by lowering ash content. On the other hand, the process retained most of the nutritional values of the raw material. It did so by using a chemically gentle and inexpensive method to release the heavy metals from the organic matrix, e.g., by adding HCl acid and performing the dialysis in its presence.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method for removing one or more heavy metals from marine-originated biomass, the method comprising:
(a) contacting said biomass with a non-oxidizing acid, thereby producing an acidic suspension, paste or a mixture thereof, and
(b) separating said one or more heavy metals from said biomass,
thereby removing said one or more heavy metals from said biomass.

2. The method of claim 1, wherein said non-oxidizing acid is selected from the group consisting of hydrochloric acid (HCl), a carboxylic acid, and a combination thereof.

3. The method of claim 2, wherein said carboxylic acid is selected from the group consisting of formic acid, acetic acid, citric acid, oxalic acid, butyric acid, lactic acid, malic acid, pyruvic acid, and a combination thereof.

4. The method of claim 1, wherein the pH of said suspension following step (a) is below 6.

5. The method of claim 1, wherein step (b) is performed by osmosis.

6. The method of claim 5, wherein said osmosis is performed by semipermeable membrane.

7. The method of claim 5, wherein said osmosis is performed by dialysis.

8. The method of claim 1, wherein said marine-originated biomass is derived from a unicellular organism.

9. The method of claim 1, wherein said marine-originated biomass is derived from a prokaryotic organism.

10. The method of claim 1, wherein said marine-originated biomass is derived from a plant.

11. The method of claim 10, wherein said plant is plankton.

12. The method of claim 1, wherein said marine-originated biomass is derived from an animal.

13. The method of claim 12, wherein said animal is selected from the group consisting of zooplankton, and filter feeders.

14. The method of any of claim 1, wherein said one or more heavy metals are selected from the group consisting of lead, mercury, arsenic, cadmium, and any combination thereof.

15. The method of claim 1, further comprising a step (i) of disrupting the membranes of said biomass prior to step (a), so as to liberate therefrom a content of enclosed compartments of said biomass, thereby obtaining said paste or said suspension, wherein said paste or said suspension comprise a liquid portion.

16. The method of claim 1, further comprising a step of (ii) raising the specific gravity of said liquid portion of said paste or said suspension.

17. The method of claim 16, wherein said liquid portion is characterized by a specific gravity value greater than 1.

18. The method of claim 1, further comprising a step of centrifuging said paste, thereby precipitating a mineral content and separating thereof from said paste or from said suspension.

19. The method of claim 18, wherein said step of centrifuging is performed at 1,000 g to 10,000 g.
